(19) United States
(12) Patent Application Publication
(10) Pub. No.: US 2022/0112610 A1
(43) Pub. Date: Apr. 14, 2022

(54) COVERS FOR ELECTRONIC DEVICES

(71) Applicant: Hewlett-Packard Development Company, L.P., Spring, TX (US)

(72) Inventors: Kuan-Ting Wu, Taipei City (TW); Chi Hao Chang, Taipei City (TW); Hsing Hung Hsieh, Taipei City (TW)

(73) Assignee: Hewlett-Packard Development Company, L.P., Spring, TX (US)

(21) Appl. No.: 17/425,122

(22) PCT Filed: Apr. 5, 2019
(86) PCT No.: PCT/US2019/025955

§ 371 Date: Jul. 22, 2021

(51) Int. Cl. C23C 28/00; A45C 11/00

(52) U.S. Cl. CPC C23C 28/34; A45C 11/00; C25D 13/04; A45C 2011/002; A45C 2011/001; A45C 2011/003

(57) ABSTRACT

The present disclosure is drawn to covers for electronic devices, methods of making the covers, and electronic devices. In one example, a cover for an electronic device comprising: a metal cover substrate having at least a top surface and a bottom surface; a transparent passivation layer on the top surface of the metal cover substrate; a water-borne graphene coating layer on the transparent passivation layer; and an electrophoretic deposition coating layer on the water-borne graphene coating layer.

### BACKGROUND

The use of personal electronic devices of all types continues to increase. Cellular phones, including smartphones, have become nearly ubiquitous. Tablet computers have also become widely used in recent years. Portable laptop computers continue to be used by many for personal, entertainment, and business purposes. For portable electronic devices in particular, much effort has been expended to make these devices more useful and more powerful while at the same time making the devices smaller, lighter, and more durable. The aesthetic design of personal electronic devices is also of concern in this competitive market.

### BRIEF DESCRIPTION OF THE DRAWING

FIG. 1 is a cross-sectional view illustrating an example cover for an electronic device in accordance with examples of the present disclosure;

FIG. 2 is a cross-sectional view illustrating another example cover for an electronic device in accordance with examples of the present disclosure;

FIG. 3 is a flowchart illustrating an example method of making a cover for an electronic device in accordance with examples of the present disclosure; and

FIG. 4 is a flowchart illustrating another example method of making a cover for an electronic device in accordance with examples of the present disclosure.

### DETAILED DESCRIPTION

It can be difficult to offer luster producing metallic covers for electronic devices because metallic covers, which containin metal alloys, tend to oxidize on the cover surface naturally over time. Thus, any luster on these metallic covers can be lost making the electronic device cover look dull and unsatisfactory.

While there are a few techniques to reduce or eliminate oxidation of the surface of metallic covers for electronic devices, there is a need for environmentally friendly surface finishing solutions that have high durability to reduce or eliminate such surface oxidation.

Described herein, in some examples, is a water-borne graphene coating layer which is used to develop a durable surface finish on metal alloy substrates for electronic device covers. The water-borne graphene coating layer can be conductive with a resistance of less than about 30 ohms per square inch. The water-borne graphene coating layer, as described herein, can have a high aspect ratio, which can act as a barrier coating layer to smooth out a metal substrate surface and enhance surface hardness.

In some examples, the water-borne graphene coating layer can be coated with a substantially uniform and smooth electrophoretic deposition coating layer with a silky touch.

In some examples, a transparent passivation layer is first applied to the surface of a metal substrate. The combination of the transparent passivation layer and the electrophoretic deposition coating layer can offer a durable anti-rusting or reduced rusting ability to the metal substrate.

The present disclosure is drawn to covers for electronic devices, methods of making the covers, and electronic devices.

In some examples, described herein is a cover for an electronic device comprising: a metal cover substrate having at least a top surface and a bottom surface; a transparent passivation layer on the top surface of the metal cover substrate; a water-borne graphene coating layer on the transparent passivation layer; and an electrophoretic deposition coating layer on the water-borne graphene coating layer.

In some examples, the cover further comprises: a transparent passivation layer on the bottom surface of the metal cover substrate.

In some examples, the cover further comprises: an electrophoretic deposition coating layer on the transparent passivation layer on the bottom surface of the metal cover substrate.

In some examples, the metal cover substrate comprises aluminum, magnesium, lithium, titanium, zinc, niobium, stainless steel, or an alloy thereof.

In some examples, the transparent passivation layer on the bottom surface and the top surface each have a thickness of about 30 nm to about 1 μm.

In some examples, the transparent passivation layer comprises a chelating agent and a metal ion, a chelated metal complex of the chelating agent and the metal ion, an oxide of the metal ion, or a combination thereof, wherein the metal ion is an aluminum ion, an indium ion, a nickel ion, a chromium ion, a tin ion, or a zinc ion.

In some examples, the water-borne graphene coating layer has a thickness of from about 5 μm to about 15 μm.

In some examples, the electrophoretic deposition layers each have a thickness of from about 6 μm to about 40 μm.

In some examples, described herein is an electronic device comprising the cover described hereinabove.

In some examples, described herein is an electronic device comprising: an electronic component and a cover at least partially enclosing the electronic component, wherein the cover comprises: a metal cover substrate having at least a top surface and a bottom surface; a transparent passivation layer on the top surface of the metal cover substrate; a water-borne graphene coating layer on the transparent passivation layer; an electrophoretic deposition coating layer on the water-borne graphene coating layer; a transparent passivation layer on the bottom surface of the metal cover substrate; and an electrophoretic deposition coating layer on the transparent passivation layer on the bottom surface of the metal cover substrate.

In some examples, the electronic device is a laptop, tablet computer, smartphone, an e-reader, or a music player.

In some examples, the water-borne graphene coating layer comprises polyacrylic, polyurethane, polyamide, polyester, and combinations thereof.

In some examples, the electrophoretic deposition coating layer comprises a polymeric binder, a pigment, and a dispersant.

In some examples, described herein is a method of making a cover for an electronic device comprising: forming a transparent passivation layer on a top surface and a bottom surface of a metal cover substrate; applying a water-borne graphene coating layer on the transparent passivation layer on the top surface of the metal cover substrate; depositing an electrophoretic deposition coating layer on the water-borne graphene coating layer; depositing an electrophoretic deposition coating layer on the transparent passivation layer on the bottom surface of the metal cover substrate.

In some examples, the metal cover substrate comprises aluminum, magnesium, lithium, titanium, zinc, niobium, stainless steel, or an alloy thereof.

### Covers for Electronic Devices

The present disclosure describes covers for electronic devices that can be durable, strong, and lightweight and have a decorative appearance. In some cases, light metal materials can be used to make covers for electronic devices. Generally, light metals can include aluminum, magnesium, titanium, lithium, niobium, zinc, and alloys thereof. Covers can also be made from stainless steel in some cases. These materials can have useful properties, such as low weight, high strength, and an appealing appearance. However, some of these metals can be easily oxidized at the surface, and may be vulnerable to corrosion or other chemical reactions at the surface. For example, magnesium or magnesium alloys in particular can be used to form covers for electronic devices because of the low weight and high strength of magnesium. Magnesium can have a somewhat porous surface that can be vulnerable to chemical reactions and corrosion at the surface. In some examples, magnesium or magnesium alloy can be treated by micro-arc oxidation to form a layer of protective oxide at the surface. This protective oxide layer can increase the chemical resistance, hardness, and durability of the magnesium or magnesium alloy. However, micro-arc oxidation can also create a dull appearance instead of the original luster of the metal.

The present disclosure describes covers for electronic devices that can utilize the above metals for their favorable properties and at the same time the metals can be protected from corrosion. Furthermore, the covers can have an attractive appearance. In some cases, it can be desirable to chamfer certain edges of the cover for ergonomics and/or to enhance the appearance of the cover. Some examples of edges that may be chamfered can include an edge surrounding a track pad on a lap top, an edge surrounding a fingerprint scanner, an outer edge of a smartphone housing, and so on.

FIG. 1 shows an example cover 100 for an electronic device. The cover 100 comprises: a metal cover substrate 110 having at least a top surface and a bottom surface; a transparent passivation layer 120 on the top surface of the metal cover substrate; a water-borne graphene coating layer 130 on the transparent passivation layer; and an electrophoretic deposition coating layer 140 on the water-borne graphene coating layer.

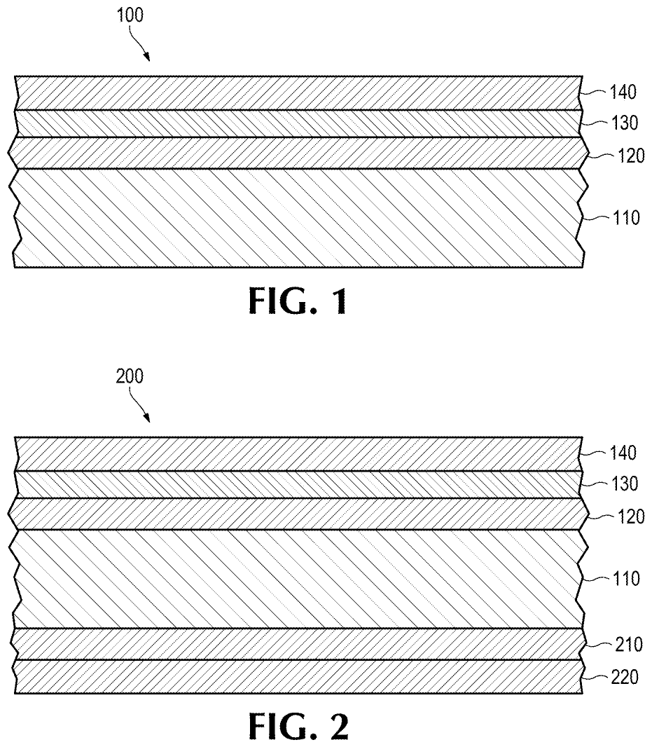

FIG. 2 shows an example cover 200 for an electronic device. The cover 200 comprises: a metal cover substrate having at least a top surface and a bottom surface; a transparent passivation layer 120 on the top surface of the metal cover substrate; a water-borne graphene coating layer 130 on the transparent passivation layer; an electrophoretic deposition coating layer 140 on the water-borne graphene coating layer; a transparent passivation layer 210 on the bottom surface of the metal cover substrate; and an electrophoretic deposition coating layer 220 on the transparent passivation layer on the bottom surface of the metal cover substrate.

As used herein, “cover” refers to the exterior shell of an electronic device. In other words, the cover contains the internal electronic components of the electronic device. The cover is an integral part of the electronic device. The term “cover” is not meant to refer to the type of removable protective cases that are often purchased separately for an electronic device (especially smartphones and tablets) and placed around the exterior of the electronic device. Covers as described herein can be used on a variety of electronic devices. For example, laptop computers, smartphones, tablet computers, and other electronic devices can include the covers described herein. In various examples, the metal cover substrates for these covers can be formed by molding, casting, machining, bending, working, stamping, or another process. In one example, a metal cover substrate can be milled from a single block of metal. In other examples, the cover can be made from multiple panels. For example, laptop covers sometimes include four separate cover pieces forming the complete cover of the laptop. The four separate pieces of the laptop cover are often designated as cover A (back cover of the monitor portion of the laptop), cover B (front cover of the monitor portion), cover C (top cover of the keyboard portion) and cover D (bottom cover of the keyboard portion). Covers can also be made for smartphones and tablet computers with a single metal piece or multiple metal panels.

As used herein, a layer that is referred to as being “on” a lower layer can be directly applied to the lower layer, or an intervening layer or multiple intervening layers can be located between the layer and the lower layer. Generally, the covers described herein can include a metal cover substrate and a micro-arc oxidation layer or a non-transparent passivation treatment layer on a surface of the metal cover substrate. Accordingly, a layer that is “on” a lower layer can be located further from the metal cover substrate. However, in some examples there may be other intervening layers such as a primer coating layer underneath the micro-arc oxidation layer or the non-transparent passivation treatment layer. Thus, a “higher” layer applied “on” a “lower” layer may be located farther from the metal cover substrate and closer to a viewer viewing the cover from the outside.

It is noted that when discussing covers for electronic devices, the electronic devices themselves, or methods of making covers for electronic devices, such discussions can be considered applicable to one another whether or not they are explicitly discussed in the context of that example. Thus, for example, when discussing the metals used in the metal cover substrate in the context of one of the example covers, such disclosure is also relevant to and directly supported in the context of the electronic devices and/or methods, and vice versa. It is also understood that terms used herein will take on their ordinary meaning in the relevant technical field unless specified otherwise. In some instances, there are terms defined more specifically throughout or included at the end of the present disclosure, and thus, these terms are supplemented as having a meaning described herein.

### Electronic Devices

A variety of electronic devices can be made with the covers described herein. In various examples, such electronic devices can include various electronic components enclosed by the cover. As used herein, “encloses” or “enclosed” when used with respect to the covers enclosing electronic components can include covers completely enclosing the electronic components or partially enclosing the electronic components. Many electronic devices include openings for charging ports, input/output ports, headphone ports, and so on. Accordingly, in some examples the cover can include openings for these purposes. Certain electronic components may be designed to be exposed through an opening in the cover, such as display screens, keyboard keys, buttons, track pads, fingerprint scanners, cameras, and so on. Accordingly, the covers described herein can include openings for these components. Other electronic components may be designed to be completely enclosed, such as motherboards, batteries, sim cards, wireless transceivers, memory storage drives, and so on. Additionally, in some examples a cover can be made up of two or more cover sections, and the cover sections can be assembled together with the electronic components to enclose the electronic components. As used herein, the term “cover” can refer to an individual cover section or panel, or collectively to the cover sections or panels that can be assembled together with electronic components to make the complete electronic device.

In some examples, the electronic devices can be personal computers, laptops, tablet computers, e-readers, music players, smartphones, mouse, keyboards, or a variety of other types of electronic devices. In certain examples, the chamfered edge or edges can be located in decorative locations on the cover. Some examples include chamfered edges around track pads, around fingerprint scanners, at outer edges of the cover, at an edge of a sidewall, at an edge of a logo, and so on.

### Methods of Making Covers for Electronic Devices

In some examples, the covers described herein can be made by first forming the metal cover substrate. This can be accomplished using a variety of processes, including molding, forging, casting, machining, stamping, bending, working, and so on. The metal cover substrate can be made from a variety of metals. In certain examples, the metal cover substrate can include aluminum, magnesium, lithium, titanium, zinc, niobium, stainless steel, or an alloy thereof. As mentioned above, in some examples the metal cover substrate can be a single piece while in other examples the metal cover substrate can include multiple pieces that each make up a portion of the cover. Additionally, in some examples the metal cover substrate can be a composite made up of multiple metals combined, such as having layers of multiple different metals or panels or other portions of the metal cover substrate being different metals.

In some examples, the metal cover substrate can be subjected to degreasing and then washing to remove any impurities and particulates.

In some examples, transparent passivation layer can then be applied to any surface of the metal cover substrate, including fully or partially covering a single surface, fully or partially covering multiple surfaces, or fully or partially covering the metal cover substrate as a whole. The transparent passivation layer can be applied by any suitable application method.

In some examples, the transparent passivation layer can be applied using a passivation treatment. Some passivation treatments may include immersing the cover in a passivation treatment bath, so that all surfaces of the cover are contacted by reagents for the passivation treatment. However, in some examples the passivation treatment may affect the exposed metal cover substrate while having no effect on the surfaces that are coated with the protective coating. Transparent passivation treatments can include treatments involving a chelating agent and a metal ion or a chelated metal complex, as described in more detail below.

After the transparent passivation treatment layer, a washing step can be completed to wash/rinse any extra passivation chemicals. The washing/rinsing can be carried out through sonic cleaning.

A water-borne graphene coating layer can then be applied followed by baking at a temperature of from about 60° C. to about 120° C. for about 30 to about 90 minutes.

An electrophoretic deposition coating layer can then be applied on the water-borne graphene coating layer followed by baking at a temperature of from about 80° C. to about 180° C. for from about 30 minutes to about 120 minutes.

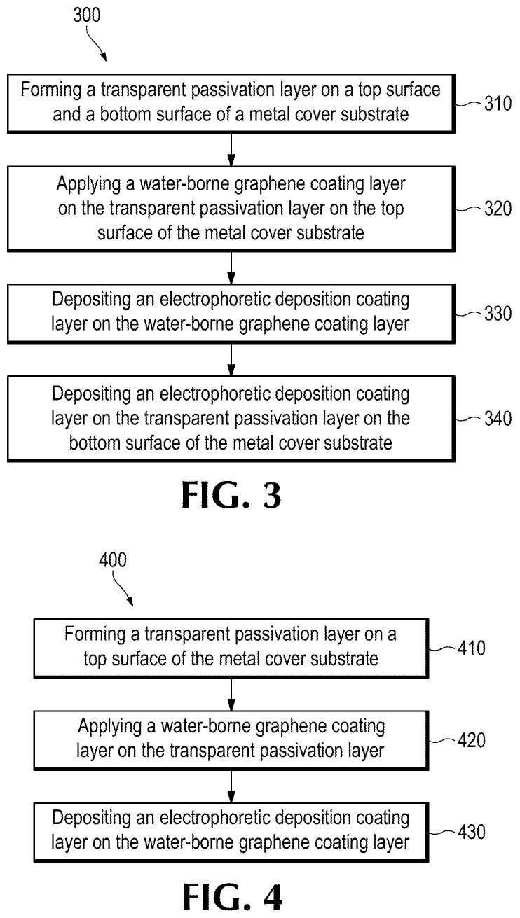

FIG. 3 is a flowchart illustrating an example method 300 of making a cover for an electronic device. The method comprises forming a transparent passivation layer on a top surface and a bottom surface of a metal cover substrate (310); applying a water-borne graphene coating layer on the transparent passivation layer on the top surface of the metal cover substrate (320); depositing an electrophoretic deposition coating layer on the water-borne graphene coating layer (330); and depositing an electrophoretic deposition coating layer on the transparent passivation layer on the bottom surface of the metal cover substrate (340).

FIG. 4 is a flowchart illustrating an example method 400 of making a cover for an electronic device. The method comprises forming a transparent passivation layer on a top surface of the metal cover substrate (410); applying a water-borne graphene coating layer on the transparent passivation layer (420); depositing an electrophoretic deposition coating layer on the water-borne graphene coating layer (430).

### Metal Cover Substrate

In some examples, the metal cover substrate comprises aluminum, magnesium, lithium, titanium, zinc, niobium, stainless steel, or an alloy thereof.

The metal cover substrate can be made from a single metal, a metallic alloy, a combination of sections made from multiple metals, or a combination of metal and other materials. In some examples, the metal cover substrate can include a light metal. In certain examples, the metal cover substrate can include aluminum, magnesium, lithium, titanium, zinc, niobium, stainless steel, or an alloy thereof. In further particular examples, the metal cover substrate can include aluminum, an aluminum alloy, magnesium, or a magnesium alloy. Non-limiting examples of elements that can be included in aluminum or magnesium alloys can include aluminum, magnesium, titanium, lithium, niobium, zinc, bismuth, copper, cadmium, iron, thorium, strontium, zirconium, manganese, nickel, lead, silver, chromium, silicon, tin, gadolinium, yttrium, calcium, antimony, cerium, lanthanum, or others.

In some examples, the metal cover substrate can include an aluminum magnesium alloys made up of about 0.5% to about 13% magnesium by weight and 87% to 99.5% aluminum by weight. Examples of specific aluminum magnesium alloys can include 1050, 1060, 1199, 2014, 2024, 2219, 3004, 4041, 5005, 5010, 5019, 5024, 5026, 5050, 5052, 5056, 5059, 5083, 5086, 5154, 5182, 5252, 5254, 5356, 5454, 5456, 5457, 5557, 5652, 5657, 5754, 6005, 6005A, 6060, 6061, 6063, 6066, 6070, 6082, 6105, 6162, 6262, 6351, 6463, 7005, 7022, 7068, 7072, 7075, 7079, 7116, 7129, and 7178.

In further examples, the metal cover substrate can include magnesium metal, a magnesium alloy that is 99% or more magnesium by weight, or a magnesium alloy that is from about 50% to about 99% magnesium by weight. In a particular example, the metal cover substrate can include an alloy including magnesium and aluminum. Examples of magnesium-aluminum alloys can include alloys made up of from about 91% to about 99% magnesium by weight and from about 1% to about 9% aluminum by weight, and alloys made up of about 0.5% to about 13% magnesium by weight and 87% to 99.5% aluminum by weight. Specific examples of magnesium-aluminum alloys can include AZ63, AZ81, AZ91, AM50, AM60, AZ31, AZ61, AZ80, AE44, AJ62A, ALZ391, AMCa602, LZ91, and Magnox.

The metal cover substrate can be shaped to fit any type of electronic device, including the specific types of electronic devices described herein. In some examples, the metal cover substrate can have any thickness suitable for a particular type of electronic device. The thickness of the metal in the metal cover substrate can be selected to provide a desired level of strength and weight for the cover of the electronic device. In some examples, the metal cover substrate can have a thickness from about 0.5 mm to about 2 cm, from about 1 mm to about 1.5 cm, from about 1.5 mm to about 1.5 cm, from about 2 mm to about 1 cm, from about 3 mm to about 1 cm, from about 4 mm to about 1 cm, or from about 1 mm to about 5 mm, though thicknesses outside of these ranges can be used.

In still further examples, the metal cover substrate can include a metal having a transparent passivation layer on a surface thereof. Some passivation treatments may include immersing the cover in a passivation treatment bath, so that all surfaces of the cover are contacted by reagents for the passivation treatment. However, in some examples the passivation treatment may affect the exposed metal cover substrate while having no effect on the surfaces that are coated with the protective coating. Transparent passivation treatments can include treatments involving a chelating agent and a metal ion or a chelated metal complex, as described in more detail below.

A water-borne graphene coating layer and then an electrophoretic deposition coating layer are formed on the transparent passivation layer.

### Transparent Passivation Layers

In some examples, the transparent passivation layer comprises a chelating agent and a metal ion, a chelated metal complex of the chelating agent and the metal ion, an oxide of the metal ion, or a combination thereof, wherein the metal ion is an aluminum ion, an indium ion, a nickel ion, a chromium ion, a tin ion, or a zinc ion.

In some examples, a passivation treatment can be used to form a transparent passivation layer at the metal cover substrate exposed at the chamfered edge. It is noted that the transparent passivation layer is described as a layer for convenience, and thus, can be in the form of a layer. However, the term “passivation layer” also includes metal surface treatment of the exposed metal substrate. In some sense, it may not be a discrete layer that is applied similarly to that of a coating or a paint, for example, but can become infused or otherwise become part of the metal substrate at or near a surface of the chamfered edge. In some examples, the transparent passivation layer can include a chelating agent and a metal ion or a chelated metal complex thereof, wherein the metal ion is an aluminum ion, an indium ion, a nickel ion, a chromium ion, a tin ion, or a zinc ion. In certain examples, passivation treatment can be applied at a pH from about 2 to about 5. In a particular example, the pH can be about 2.5 to about 3.5.

In further examples, the transparent passivation layer can include an oxide of one of these metals. In some cases, various contaminants can be present on the surface of the metal cover substrate. The chelating agent can chelate such contaminants and prevent the contaminants from attaching to the surface of the metal cover substrate. Non-limiting examples of chelating agents can include ethylenediaminetetraacetic acid, ethylenediamine, nitrilotriacetic acid, diethylenetriaminepenta(methylenephosphonic acid), nitrilotris(methylenephosphonic acid) and 1-hydroxyethane-1,1-disphosphonic acid. At the same time, a passivating metal oxide layer may form on the surface of the metal cover substrate.

In some examples, the transparent passivation layer can have a thickness from about 30 nm to about 1 μm, or from about 20 nm to about 900 nm, or from about 10 nm to about 800 nm, or from about 1 nm to about 700 m, or from about 1 nm to about 600 nm, or from about 1 nm to about 500 nm, or less than 1000 nm, or less than 750 nm, or less than 500, or less than 250 nm, or less than 100 nm, or less than 50 nm, or less than 30 nm, or less than 10 nm.

In certain examples, the transparent passivation can be added to the pre-existing surface of the metal cover substrate, such that the transparent passivation layer includes additional material added onto the surface of the metal cover substrate. In other examples, the passivation layer can involve converting the existing surface of the metal cover substrate into a passive layer so that no net addition of material to the pre-existing surface occurs.

### Water-Borne Graphene Coating Layer

In some examples, a water-borne graphene coating layer is applied on the transparent passivation layer. In some examples, the water-borne graphene coating layer comprises polyacrylic, polyurethane, polyamide, polyester, and combinations thereof.

In some examples, the water-borne graphene coating layer has a thickness of from about 5 μm to about 15 μm, or from about 7 μm to about 13 μm, or from about 9 μm to about 11 μm, or less than 15 μm, or less than 14 μm, or less than 12 μm, or less than 10 μm, or less than 8 μm, or less than 6 μm.

The water-borne graphene coating layer can be applied on the transparent passivation layer using any layer/film application process.

The water-borne graphene coating layer can be prepared by mixing and dissolving graphene and a binder in a solvent to obtain a slurry, which is then filtered and applied to the transparent passivation layer. After application, the water-borne graphene coating layer is baked on for from about 30 to about 90 minutes at a temperature of from about 60° C. to about 120° C.

The binder comprises polyacrylic, polyurethane, polyamide, polyester, or combinations thereof in an amount of from about 1 wt % to about 30 wt % based on the total weight of the water-borne graphene coating layer.

The graphene can be a laminar carbon material comprising a single layer or 1 to 50 sublayers, the structure inside the sublayers being hexagonal honeycomb lattices formed by hybrid orbitals of carbon atoms, and the structure between the sublayers being formed of carbon atoms bound by π bond. In some examples, the graphene layer is a graphene material containing one or more of fluorine, nitrogen, oxygen, carbonyl, carboxyl, and hydroxyl and/or intercalated graphene.

In some examples, the solvent can comprise water and optionally one or more organic solvents. The solvent makes up the balance of the water-borne graphene coating slurry. The water-borne graphene coating layer formed from the water-borne graphene coating slurry is environmentally friendly because it has low levels of organic solvents—from about 5 wt % to about 25 wt % organic solvents (based on the total weight of the solvents in the slurry) such as alcohols including isopropanol or Isobutyl alcohol.

### Electrophoretic Deposition Coating Layer

The electrophoretic coating can include a polymeric binder, a pigment, and a dispersant. The electrophoretic coating process can sometimes be referred to as “electropainting” or “electrocoating” because of the use of electric current in the process. To deposit an electrophoretic coating on the cover for the electronic device, the cover (including the aluminum or aluminum alloy cover frame and the magnesium or magnesium alloy cover panel) can be placed in a coating bath. The coating bath can include a suspension of particles including the polymeric binder, pigment, and dispersant. In certain examples, the solids content of the coating bath can be from about 3 wt % to about 30 wt % or from about 5 wt % to about 15 wt %. The cover can be electrically connected to an electric power source. The cover can act as one electrode and the power source can also be attached to a second electrode that is also in contact with the coating bath. An electric current can be run between the cover and the second electrode. In certain examples, the electric current can be applied at a voltage from about 20 V to about 150 V. The electric current can cause the particles suspended in the coating bath to migrate to the surface of the cover and coat the surface. After this deposition process, additional processing may be performed such as rinsing the cover, baking the coated cover to harden the coating, or exposing the coated cover to radiation to cure radiation curable polymeric binders.

In some examples, electrophoretic deposition coating layers can include the same pigments and polymeric binders or resins described above in the paint-type protective coating. The thickness of the coating can also be in the same ranges described above.

In some examples, the electrophoretic deposition coating layers can be a paint coating comprising a colorant and a polymeric binder.

In some examples, the electrophoretic deposition coating layers can include a polymer resin. In certain examples, the polymer resin can be transparent and the electrophoretic deposition coating layers can be a clear coat layer that allows the color of the underlying materials to show through. In further examples, the electrophoretic deposition coating layers may be colored. In a particular example, the electrophoretic deposition coating layers can include a layer of colored coating and a layer of clear coating on the colored coating. In some examples, the polymer resin of the clear coat layer can be clear poly(meth)acrylic, clear polyurethane, clear urethane (meth)acrylate, clear (meth)acrylic (meth)acrylate, or clear epoxy (meth)acrylate coating.

In further examples, the electrophoretic deposition coating layers can include fillers such as pigment dispersed in an organic polymer resin. Non-limiting examples of pigments used in the protective coating layer can include carbon black, titanium dioxide, clay, mica, talc, barium sulfate, calcium carbonate, synthetic pigment, metallic powder, aluminum oxide, graphene, pearl pigment, dye, or a combination thereof. The pigment can be present in the protective coating layer in an amount from about 0.5 wt % to about 30 wt % with respect to dry components of the electrophoretic deposition coating layer, in some examples. In other examples, the amount of pigment can be from about 1 wt % to about 25 wt % or from about 2 wt % to about 15 wt % with respect to dry components of the electrophoretic deposition coating layers.

The polymer resin included in the electrophoretic deposition coating layers with the pigment can include polyester, poly(meth)acrylic, polyurethane, epoxy, urethane (meth)acrylic, (meth)acrylic (meth)acrylate, epoxy (meth)acrylate, or a combination thereof. As used herein, a “combination” of multiple different polymers can refer to a blend of homopolymers, a copolymer made up of the different polymers or monomers thereof, or adjacent layers of the different polymers. In certain examples, the polymer resin of the electrophoretic deposition coating layer can have a weight-average molecular weight from about 100 g/mol to about 6,000 g/mol.

The thickness of the electrophoretic deposition coating layer can be from about 6 μm to about 40 μm in some examples. In further examples, the thickness can be from about 8 μm to about 35 μm, or less than about 40 μm, or less than about 35 μm, or less than about 30 μm, or less than about 25 μm, or less than about 20 μm, or less than about 15 μm, or less than about 10 μm.

In certain examples, the electrophoretic deposition coating layer can include a base coat that is colored and a top coat that is clear. Thus, the colored layer and the clear coat layer described above can be used together in certain examples. The overall thickness of the base coat with the top coat can be from about 10 μm to about 55 μm, from about 12 μm to about 50 μm, or from about 15 μm to about 40 μm, in some examples.

In further examples, the colored electrophoretic deposition coating layer, the top clear coat layer, or both, can be radiation curable. The polymer resin used in these layers can be curable using heat and/or radiation. For example, a heat curing polymer resin can be used and then cured in an oven for a sufficient curing time. A radiation curing polymer resin can be exposed to sufficient radiation energy to cure the polymer resin. The electrophoretic deposition coating layer can be cured after applying the layer to the cover. In certain examples, curing can include heating the electrophoretic deposition coating layer at a temperature from about 50° C. to about 80° C. or from about 50° C. to about 60° C. or from about 60° C. to about 80° C. The layer can be heated for a curing time from about 5 minutes to about 40 minutes. or from about 5 minutes to about 10 minutes, or from about 20 minutes to about 40 minutes. In other examples, curing can include exposing the layer to radiation energy at an intensity from about 500 mJ/cm2 to about 2,000 mJ/cm2 or from about 700 mJ/cm2 to about 1,300 mJ/cm2. The layer can be exposed to the radiation energy fora curing time from about 5 seconds to about 30 seconds, or from about 10 seconds to about 30 seconds.

The electrophoretic deposition coating layer can include a polymeric binder, a pigment, and a dispersant. The electrophoretic coating process can sometimes be referred to as “electropainting” or “electrocoating” because of the use of electric current in the process. To deposit an electrophoretic coating on the coated cover of the electronic device, the coated metal cover substrate can be placed in a coating bath. The coating bath can include a suspension of particles including the polymeric binder, pigment, and dispersant. In certain examples, the solids content of the coating bath can be from about 3 wt % to about 30 wt % or from about 5 wt % to about 15 wt %. The metal cover substrate can be electrically connected to an electric power source. The metal cover substrate can act as one electrode and the power source can also be attached to a second electrode that is also in contact with the coating bath. An electric current can be run between the metal cover substrate and the second electrode. In certain examples, the electric current can be applied at a voltage from about 20 V to about 150 V. The electric current can cause the particles suspended in the coating bath to migrate to the surface of the metal cover substrate and coat the surface. After this deposition process, additional processing may be performed such as rinsing the metal cover substrate, baking the coated substrate to harden the coating, or exposing the coated substrate to radiation to cure radiation curable polymeric binders.

In some examples, electrophoretic coatings can include the same pigments and polymeric binders or resins described above in the paint-type protective coating. The thickness of the coating can also be in the same ranges described above.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “liquid vehicle” or “ink vehicle” refers to a liquid fluid in an ink. A wide variety of ink vehicles may be used with the systems and methods of the present disclosure. Such ink vehicles may include a mixture of a variety of different agents, including, surfactants, solvents, co-solvents, anti-kogation agents, buffers, biocides, sequestering agents, viscosity modifiers, surface-active agents, water, etc.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants and other pigments such as organometallics, ferrites, ceramics, etc. In one specific example, however, the pigment is a pigment colorant

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

What is claimed is:

1. A cover for an electronic device comprising:
a metal cover substrate having at least a top surface and a bottom surface;
a transparent passivation layer on the top surface of the metal cover substrate;
a water-borne graphene coating layer on the transparent passivation layer; and
an electrophoretic deposition coating layer on the water-borne graphene coating layer.

2. The cover of claim 1, further comprising:
a transparent passivation layer on the bottom surface of the metal cover substrate.

3. The cover of claim 2, further comprising:
an electrophoretic deposition coating layer on the transparent passivation layer on the bottom surface of the metal cover substrate.

4. The cover of claim 1, wherein the metal cover substrate comprises aluminum, magnesium, lithium, titanium, zinc, niobium, stainless steel, or an alloy thereof.

5. The cover of claim 2, wherein the transparent passivation layer on the bottom surface and the top surface each have a thickness of about 30 nm to about 1 μm.

6. The cover of claim 5, wherein the transparent passivation layer comprises a chelating agent and a metal ion, a chelated metal complex of the chelating agent and the metal ion, an oxide of the metal ion, or a combination thereof, wherein the metal ion is an aluminum ion, an indium ion, a nickel ion, a chromium ion, a tin ion, or a zinc ion.

7. The cover of claim 1, wherein the water-borne graphene coating layer has a thickness of from about 5 μm to about 15 μm.

8. The cover of claim 3, wherein the electrophoretic deposition layers each have a thickness of from about 6 μm to about 40 μm.

9. An electronic device comprising the cover of claim 1.

10. An electronic device comprising:
an electronic component and a cover at least partially enclosing the electronic component, wherein the cover comprises:
a metal cover substrate having at least a top surface and a bottom surface;
a transparent passivation layer on the top surface of the metal cover substrate;
a water-borne graphene coating layer on the transparent passivation layer;
an electrophoretic deposition coating layer on the water-borne graphene coating layer;
a transparent passivation layer on the bottom surface of the metal cover substrate; and
an electrophoretic deposition coating layer on the transparent passivation layer on the bottom surface of the metal cover substrate.

11. The electronic device of claim 10, wherein the electronic device is a laptop, tablet computer, smartphone, an e-reader, or a music player.

12. The electronic device of claim 10, wherein the water-borne graphene coating layer comprises polyacrylic, polyurethane, polyamide, polyester, and combinations thereof.

13. The electronic device of claim 10, wherein the electrophoretic deposition coating layer comprises a polymeric binder, a pigment, and a dispersant.

14. A method of making a cover for an electronic device comprising:
forming a transparent passivation layer on a top surface and a bottom surface of a metal cover substrate;
applying a water-borne graphene coating layer on the transparent passivation layer on the top surface of the metal cover substrate;
depositing an electrophoretic deposition coating layer on the water-borne graphene coating layer;
depositing an electrophoretic deposition coating layer on the transparent passivation layer on the bottom surface of the metal cover substrate.

15. The method of claim 14, wherein the metal cover substrate comprises aluminum, magnesium, lithium, titanium, zinc, niobium, stainless steel, or an alloy thereof.
